(19) United States
(12) Patent Application Publication
(10) Pub. No.: US 2019/0336798 A1
(43) Pub. Date: Nov. 7, 2019

(54) WATERPROOF MASCARA SYSTEM

(71) Applicant: Michelle Takemoto, Honolulu, HI (US)

(72) Inventor: Michelle Takemoto, Honolulu, HI (US)

(21) Appl. No.: 16/033,034

(22) Filed: Jul. 11, 2018

Related U.S. Application Data
(60) Provisional application No. 62/665,099, filed on May 1, 2018.

(51) Int. Cl. A61Q 1/10; A46B 9/02

(52) U.S. Cl. CPC A61Q 1/10; A45D 34/045; A46B 9/021

(57) ABSTRACT

A waterproof mascara system including a waterproof mascara made of a latex enamel high gloss paint, an applicator wand having a shaft, a first-end, and a second-end, and a storage tube. The waterproof mascara is provided in the storage tube; the storage tube further housing and storing the applicator wand between uses. The waterproof mascara further includes an acrylic binding agent. A water solvent spreads the acrylic binding agent, allowing the latex enamel high gloss paint to flow and coat eyelashes. The applicator wand is configured to apply the waterproof mascara to the eyelashes of a user for long lasting wear.

### CROSS REFERENCE TO RELATED APPLICATION

The present application is related to and claims priority to U.S. Provisional Patent Application No. 62/665,099 filed May 1, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of makeup and more specifically relates to mascara and application devices.

### 2. Description of Related Art

Standard mascara is wax-based and requires expensive chemical solutions (i.e., makeup removers) to remove mascara from the face. People may use oil-based ointments to cleanse the eyelashes; however, this method can be ineffective and cost an extensive amount of money. Further, people are exposed to chemicals in the makeup remover which can be harmful if accidentally dropped in the eye. A suitable solution is desired.

U.S. Pat. No. 8,597,626 to Hy Si Bui relates to a long wear, waterproof mascara composition with water washability. The described long wear, waterproof mascara composition with water washability having a unique texture and feel including (a) at least one sugar silicone surfactant; (b) at least one oil-soluble polar modified polymer; and (c) at least one oil-soluble high carbon polar modified polymer.

### BRIEF SUMMARY OF THE INVENTION

In view of the foregoing disadvantages inherent in the known makeup art, the present disclosure provides a novel waterproof mascara system. The general purpose of the present disclosure, which will be described subsequently in greater detail, is to provide a convenient and easy-to-remove mascara when compared to standard wax-based mascaras.

A waterproof mascara system is disclosed herein. The waterproof mascara system includes a waterproof mascara comprised of a latex enamel high gloss paint, an applicator wand having a shaft, a first-end, a second-end, and a storage tube. The waterproof mascara is provided in the storage tube; the storage tube further housing and storing the applicator wand between uses. The applicator wand comprises a handle positioned at the first-end of the applicator wand. The applicator wand comprises a brush-head including a plurality of bristles at a second-end of the applicator wand. The waterproof mascara further includes an acrylic binding agent. A water solvent spreads the acrylic binding agent, allowing the latex enamel high gloss paint to flow and coat eyelashes. The applicator wand is configured to apply the waterproof mascara to the eyelashes of a user.

A kit is also disclosed herein including a waterproof mascara comprised of a latex enamel high gloss paint, an applicator wand, a storage tube, and a set of instructions.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a waterproof mascara system, constructed and operative according to the teachings of the present disclosure.

FIG. 1 is a perspective view of the waterproof mascara system during an ‘in-use’ condition, according to an embodiment of the disclosure.

FIG. 2 is a perspective view of the waterproof mascara system of FIG. 1, including an applicator wand and storage container according to an embodiment of the present disclosure.

FIG. 3 is a perspective view of the waterproof mascara system of FIG. 1, according to an embodiment of the present disclosure.

FIG. 4 is a perspective view of the waterproof mascara system of FIG. 1, according to an embodiment of the present disclosure.

FIG. 5 is a perspective view of the waterproof mascara system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to makeup and more particularly to a waterproof mascara system as used to improve mascara and application means.

Generally, the present invention provides users with waterproof mascara capable of being worn throughout the day without worry of the mascara ‘running’. The product allows wearers to wash the mascara off using soap and water instead of chemical-based makeup removers. It ensures curled eyelashes hold their shape while wearing the mascara. The product includes a convenient storage and carrying tube used to protect the mascara wand applicator and its bristles. The present invention offers a much more convenient and easy-to-remove mascara when compared to standard wax-based mascaras.

Waterproof mascara system is mascara comprised of a synthetic rubber, water-based, high-gloss latex enamel paint. The mascara is waterproof and features an acrylic binding agent used to hold the ingredients together. A water solvent spreads the binder, allowing the enamel to flow and coat eyelashes. The mascara is waterproof and can be removed without using expensive chemical makeup remover solutions. The mascara can be stored in a small tube including a wand applicator with a soft, flexible bristle tip end. Users can apply the mascara for daily use, drying and holding the shape of curled eyelashes. The mascara brush applicator may measure approximately ⅛″ in diameter with a ¾″ length brush tip.

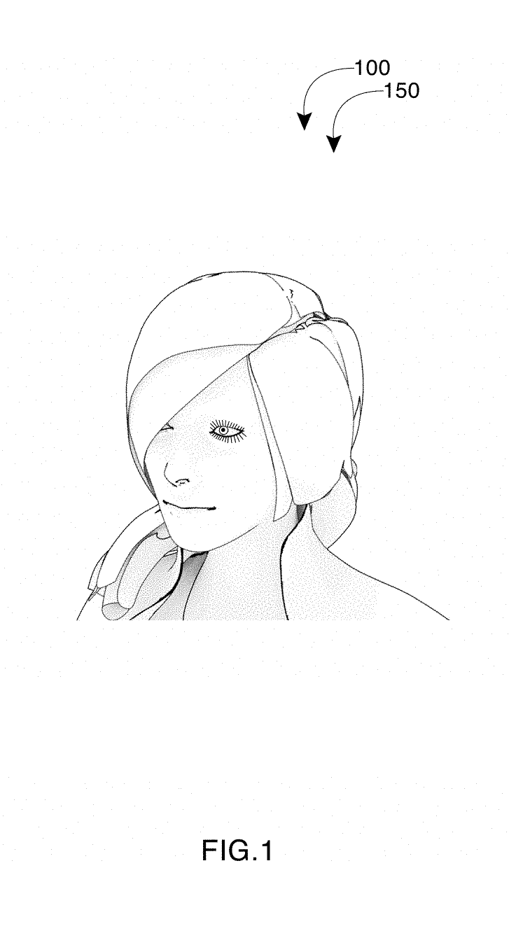

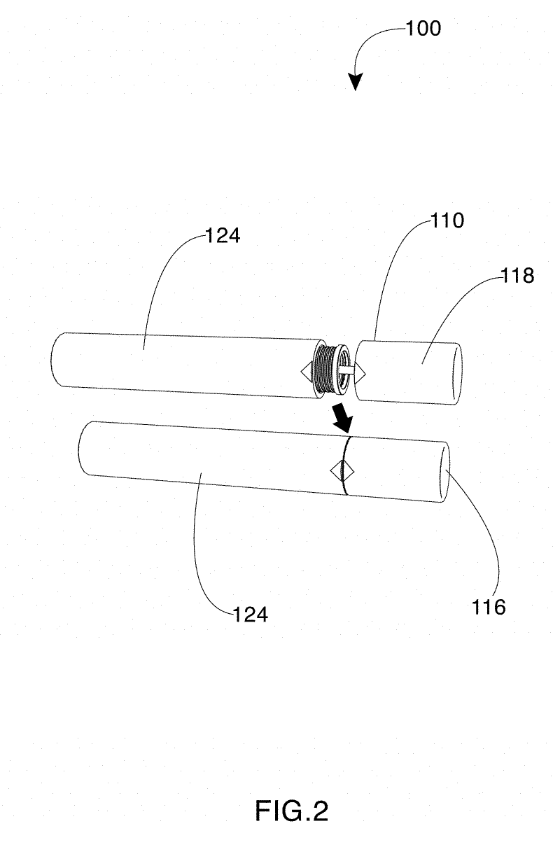

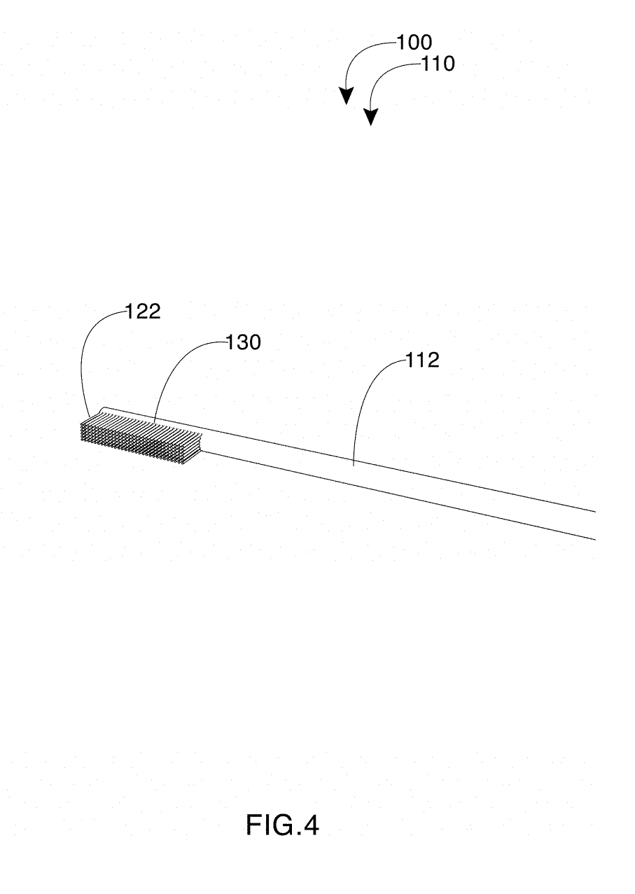

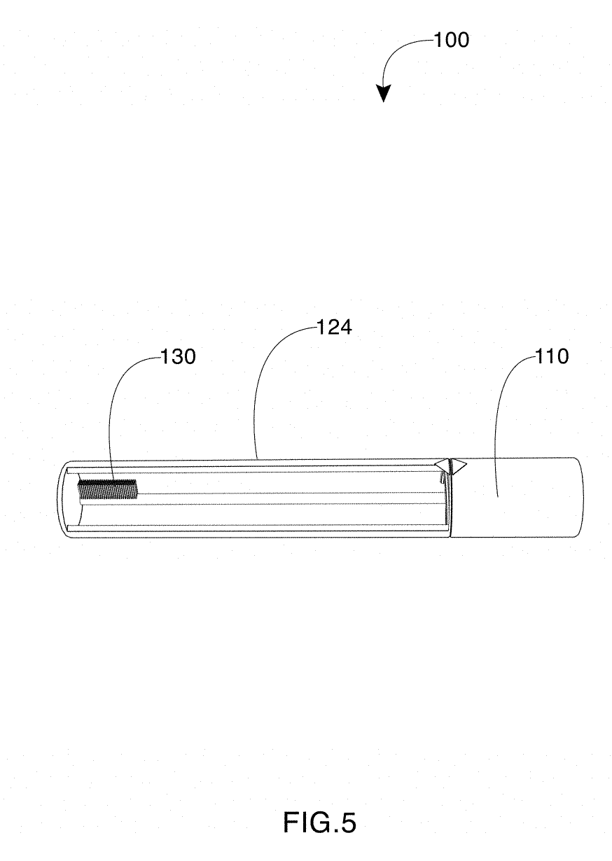

Referring now more specifically to the drawings by numerals of reference, there is shown in FIGS. 1-5, various views of a waterproof mascara system 100. FIG. 1 shows a waterproof mascara system 100 during an ‘in-use’ condition 150, according to an embodiment of the present disclosure. As illustrated, the waterproof mascara system 100 may include a waterproof mascara comprised of a latex enamel high gloss paint, an applicator wand 110 having a shaft 112, a first-end 116, a second-end 120, and a storage tube 124. The waterproof mascara is provided in the storage tube 124. The storage tube 124 further housing and storing the applicator wand 110 between uses. The waterproof mascara further includes an acrylic binding agent. A water solvent spreads the acrylic binding agent, allowing the latex enamel high gloss paint to flow and coat eyelashes. The latex enamel high gloss paint is water based. The applicator wand 110 is configured to apply the waterproof mascara to the eyelashes of a user for long lasting wear.

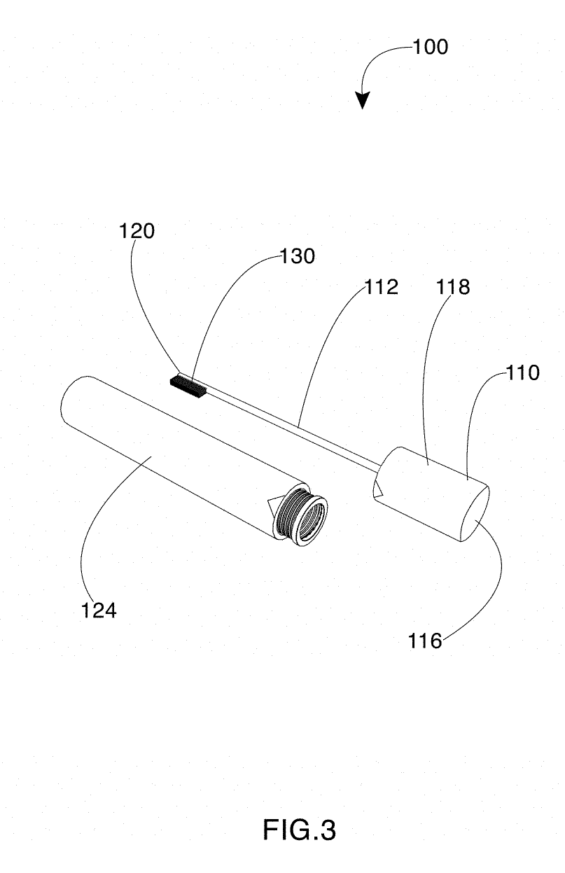

FIGS. 3-5 show various perspective views of the applicator wand and storage tube of the waterproof mascara system 100 of FIG. 1, according to an embodiment of the present disclosure. As above, the waterproof mascara system 100 may include the waterproof mascara, the applicator wand 110, and the storage tube 124. The applicator wand 110 comprises a handle 118 positioned at the first-end 116 of the applicator wand 110. The applicator wand 110 comprises a brush-head 130 including a plurality of bristles 122 at a second-end 120 of the applicator wand 110. The plurality of bristles 122 are flexible and comprise a nylon-polyester blend or other suitable material. The plurality of bristles 122 laterally extend from the applicator wand 110 and are positioned parallel to one another. The plurality of bristles 122 are provided in a series of rows and columns. The plurality of bristles 122 comprise a similar length. In a preferred embodiment, the brush-head 130 comprises a length of approximately ¾ inch.

FIG. 3 shows a perspective view of the waterproof mascara system 100 of FIG. 1, according to an embodiment of the present disclosure. As above, the waterproof mascara system 100 may include the waterproof mascara, the storage tube 124, and the applicator wand 110 defined by the shaft 112, the first-end 116, the second-end 120. The shaft 112 of the applicator wand 110 comprises a length extending between the first-end 116 and the second end 120. The shaft 112 of the applicator wand 110 includes a cylindrical profile. In a preferred embodiment, the shaft 112 comprises a diameter of approximately ⅛ inch.

The applicator wand 110 may be inserted into the storage tube 124 containing the waterproof mascara. The storage tube 124 comprises a cylindrical profile. The storage tube 124 comprises an opening configured to receive the brush-head 130 and the applicator wand 110 therethrough. With the motion of inserting and removing the applicator wand 110 from the storage tube 124, the waterproof mascara is applied to the brush-head 130 which may then be applied to a user's eyelashes. The waterproof mascara may be provided in a variety of colors and black. The waterproof mascara may be removed using soap and water in combination.

According to one embodiment, the waterproof mascara system 100 may be arranged as a kit 105. In particular, the waterproof mascara system 100 may further include a waterproof mascara comprised of a latex enamel high gloss paint; an applicator wand 110; a storage tube 124; and a set of instructions. The instructions may detail functional relationships in relation to the structure of the waterproof mascara system 100 such that the waterproof mascara system 100 can be used, maintained, or the like, in a preferred manner.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A waterproof mascara system comprising:
a waterproof mascara comprised of a latex enamel high gloss paint;
an applicator wand having;
a shaft;
a first-end;
a second-end; and
a storage tube;
wherein said waterproof mascara is provided in said storage tube, said storage tube further housing and storing said applicator wand between uses;
wherein said waterproof mascara further includes an acrylic binding agent;
wherein a water solvent spreads said acrylic binding agent, allowing said latex enamel high gloss paint to flow and coat eyelashes; and
wherein said applicator wand is configured to apply said waterproof mascara to said eyelashes of a user.

2. The waterproof mascara system of claim 1, wherein said applicator wand comprises a handle positioned at said first-end of said applicator wand.

3. The waterproof mascara system of claim 1, wherein said applicator wand comprises a brush-head including a plurality of bristles at a second-end of said applicator wand.

4. The waterproof mascara system of claim 3, wherein said plurality of bristles are flexible.

5. The waterproof mascara system of claim 4, wherein said plurality of bristles laterally extend from said applicator wand.

6. The waterproof mascara system of claim 5, wherein said plurality of bristles are positioned parallel to one another.

7. The waterproof mascara system of claim 6, wherein said plurality of bristles comprise a similar length.

8. The waterproof mascara system of claim 1, wherein said shaft of said applicator wand comprises a length extending between said first-end and said second-end.

9. The waterproof mascara system of claim 8, wherein said shaft of said applicator wand includes a cylindrical profile.

10. The waterproof mascara system of claim 9, wherein said shaft comprises a diameter of approximately ⅛ inch.

11. The waterproof mascara system of claim 1, wherein said brush-head comprises a length of approximately ¾ inch.

12. The waterproof mascara system of claim 1, wherein said plurality of bristles comprise a nylon-polyester blend material.

13. The waterproof mascara system of claim 1, wherein said plurality of bristles are provided in a series of rows and columns.

14. The waterproof mascara system of claim 1, wherein said waterproof mascara is black.

15. The waterproof mascara system of claim 1, wherein said storage tube comprises a cylindrical profile.

16. The waterproof mascara system of claim 1, wherein said storage tube comprises an opening configured to receive said brush-head and said applicator wand therethrough.

17. The waterproof mascara system of claim 1, wherein said waterproof mascara is removeable using soap and water in combination.

18. The waterproof mascara system of claim 1, wherein said latex enamel high gloss paint is water based.

19. A waterproof mascara system, the waterproof mascara system comprising:
a waterproof mascara comprised of a latex enamel high gloss paint;
an applicator wand having;
a shaft;
a first-end;
a second-end; and
a storage tube;
wherein said waterproof mascara is provided in said storage tube, said storage tube further housing and storing said applicator wand between uses;
wherein said waterproof mascara further includes an acrylic binding agent;
wherein a water solvent spreads said acrylic binding agent, allowing said latex enamel high gloss paint to flow and coat eyelashes;
wherein said applicator wand is configured to apply said waterproof mascara to said eyelashes of a user;
wherein said applicator wand comprises a handle positioned at said first-end of said applicator wand;
wherein said applicator wand comprises a brush-head including a plurality of bristles at a second-end of said applicator wand;
wherein said plurality of bristles are flexible;
wherein said plurality of bristles laterally extend from said applicator wand;
wherein said plurality of bristles are positioned parallel to one another;
wherein said plurality of bristles comprise a similar length;
wherein said plurality of bristles comprise a nylon-polyester blend material;
wherein said plurality of bristles are provided in a series of rows and columns;
wherein said shaft of said applicator wand comprises a length extending between said first-end and said second-end;
wherein said shaft of said applicator wand includes a cylindrical profile;
wherein said shaft comprises a diameter of approximately ⅛ inch;
wherein said brush-head comprises a length of approximately ¾ inch;
wherein said waterproof mascara is black;
wherein said storage tube comprises a cylindrical profile;
wherein said storage tube comprises an opening configured to receive said brush-head and said applicator wand therethrough;
wherein said waterproof mascara is removeable using soap and water in combination; and
wherein said latex enamel high gloss paint is water based.

20. The waterproof mascara system of claim 19, further comprising a waterproof mascara comprised of a latex enamel high gloss paint; an applicator wand; a storage tube; and a set of instructions; and
wherein the waterproof mascara system is arranged as a kit.
